(19) United States
(12) Patent Application Publication
(10) Pub. No.: US 2003/0147525 A1
(43) Pub. Date: Aug. 7, 2003

(54) Communications device

(76) Inventor: Mark William Eaton, Auckland (NZ)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/182,116

(22) PCT Filed: Jan. 25, 2001
(86) PCT No.: PCT/NZ01/00007

(30) Foreign Application Priority Data
Jan. 26, 2000 (NZ) 502490

(51) Int. Cl. H04M 1/00; H04M 3/00

(52) U.S. Cl. 379/355.01

(57) ABSTRACT

An improved dialling code processor (12) that is adapted to connect to a telephone line (11) in parallel with other devices (13) that use the same telephone line (11). The processor (12) may operate by: (a) detecting at least one dialling signal placed on a telephone line (11), and (b) inverting the detector signal to form a modified signal, and (c) placing the modified signal on the telephone line (11), wherein the modified signal is adapted to substantially cancel out the original detected dialling signal on the telephone line (11).

### TECHNICAL FIELD

This invention relates to improvements in communications devices. Specifically the present invention may be applied to telephone communication networks in the form of an improved dialling code processor.

These devices may be used in conjunction with telephones, facsimile machines or computer modems. Reference throughout the specification will be made to the use of present invention with telephones only, However it should be appreciated by those skilled in the art that this invention may be used in conjunction with other devices, and references to telephones only should in no way be seen as limiting.

### BACKGROUND ART

Dialling code processors have recently been developed to improve the consumers' access to alternative telecommunication networks. The applicant's U.S. Pat. No. 5,710,808 describes in detail these types of devices and their particular applications in these fields.

A dialling code processor is used where a telephone's operator wishes to connect to a telecommunications network other than that to which they would normally be connected to by default. Connection to these alternative networks requires the operator to dial an additional three or four digits to access the alternative network, followed by the telephone number of the person or persons they wish to reach.

It has been found by the operators of alternative networks that the additional digits to be dialled are an inconvenience to customers, which may also deter them from using the alternative network.

To solve these problems the dialling code processor was developed. A DCP (dialling code processor) is normally connected between a telephone network jack-point and a telephone, modem or facsimile. This device blocks the original dialling signal from the device it is connected to, and transmits its own dialling code signal, which includes the additional digits required to access an alternative telecommunications network.

The providers of alternative telecommunications networks have a great demand for these devices and, in some instances, supply them free to customers who wish to use their service.

However, existing DCP's need to be connected in series into the telephone network. This means that the DCP must be connected between a telephone and a jack-point that leads into a building's telephone line network. The serial connection of DCP's means that a DCP is required for each telephone in a building that is used to access the alternative telecommunications network. The applicant's have found that numerous organisations require large numbers of DCP's to function effectively using an alternative telecommunications network.

A single DCP is required per telephone, as in most instances it is extremely difficult to connect a DCP to a point on a structure's telephone line network where all the lines intersect and “exit” the building. In most instances these connection points are extremely difficult to gain access to, being located in ceilings or small crawl spaces in a structure. Connecting a single DCP to such positions on a building's telecommunications network is relatively impractical.

A dialling code processor that could service numerous telephones, facsimiles or modems would be a great advantage over the prior art. Further, a dialling code processor which could be easily connected into a structures telecommunications network and which did not appreciably delay the connection of a call to a telephone line through an alternative telecommunications network would be of great advantage over the prior art.

It is an object of the present invention to address the foregoing problems or at least to provide the public with a useful choice.

Further aspects and advantages of the present invention will become apparent from the ensuing description that is given by way of example only.

### DISCLOSURE OF INVENTION

According to one aspect of the present invention there is provided a method of operating a dialling code processor, characterised by the steps of:

(a) detecting at least one dialling signal placed on a telephone line, and

(b) inverting the detector signal to form a modified signal, and

(c) placing the, modified signal on the telephone line,

wherein the modified signal is adapted to substantially cancel out the original detected dialling signal on the telephone line.

According to one further aspect of the present invention there is provided a method of operating a dialling code processor, characterised by the steps of:

a) detecting at least one dialling signal placed on a telephone line, and

b) inverting the detected signal, and

c) modifying the inverted signal to form a modified signal which includes an additional code signal, and

d) placing the modified signal on the telephone line,

wherein the modified signal is adapted to substantially cancel out the original detected dialling signal on the telephone line, and to place the additional code signal on the telephone line.

According to a further aspect of the present invention there is provided a dialling code processor which includes a detector, an inverter and an output stage.

According to yet another aspect of the present invention there is provided a dialling code processor which includes a detector, an inverter formed through a microprocessor loaded with software adapted to invert a detected dialling signal, and an output stage adapted to place the inverted dialling signal on the telephone line.

According to a further aspect of the present invention there is provided a dialling code processor which includes a microprocessor or other similar device loaded with software adapted to invert a detected dialling signal and to apply a code signal to the inverted detected signal to form a modified signal.

According to another aspect of the present invention there is provided a dialling code processor that includes a detector, an inverter, a processor, a modifier, and an output stage.

According to yet another aspect of the present invention there is provided a dialling code processor substantially as described above, wherein

the detector is adapted to detect a dialling signal on a telephone line and input said dialling signal to the dialling code processor, and

the inverter is adapted to invert the signal detected by the detector, and

the processor is adapted to generate a code signal, and

the modifier is adapted to combine the code signal and the inverted signal of the inverter, and

the output stage is adapted to place the output of the modifier on the telephone line.

According to a further aspect of the present invention there is provided a dialling code processor substantially as described above wherein the inverter processor and modifier are implemented through software modules or components loaded into a microprocessor or other similar device.

A dialling code processor as referred to throughout the specification is a device which performs substantially the same function as that described in U.S. Pat. No. 5,710,808. However it should be appreciated by those skilled in the art that the particular device described in this patent is not necessarily required to implement the present invention. Any type of electrical device that performs in substantially the same manner as a dialling code processor described in U.S. Pat. No. 5,710,808 may be used in conjunction with the present invention.

In a preferred embodiment a dialling signal is detected with use of a conductor physically connected between the telephone line and the dialling code processor. This conductor may supply any signal on the telephone line to the dialling code processor. This detector may in some embodiments also include capaciture or resistive elements that ensure the signal detected is supplied to the DCP at the correct voltage or current levels.

In a preferred embodiment the dialling signal detected on a telephone line may be any signal used to connect a telephone call. In a further preferred embodiment the dialling signals detected may be DTMF (dialling tone-modulated frequency) signals. Reference throughout this specification shall now be made to the dialling signals detected as being DTMF signals. However it should be appreciated by those skilled in the art the present invention may be adapted to detect any particular type of dialling signal as required and reference to DTMF signals only and should in no way be seen as limiting.

In a preferred embodiment a signal placed on a telephone line as specified above may include the action of inducing a voltage or current signal on a telephone line to transmit the required signal on the telephone line. In this instance the dialling signal and modified signal discussed above may be easily placed on a telephone line using standard telecommunications equipment and techniques.

An output stage may be adapted to place the dialling code processor's output on the telephone lines. In a preferred embodiment a conductor may be placed in physical connection between a telephone line and other components of the present invention to forn an output stage. In this way electrical signals may be easily and quickly placed on the telephone line as required.

Preferably the dialling code processor may be adapted to be connected to a telephone line in parallel with at least one other device also connected to the same line. Through providing such a parallel connection scheme a single dialling code processor may be used to service many separate telephones or other similar devices which use a telephone line. This may result in a significant reduction in costs over the existing prior art which requires a dialling code processor to be interposed between each telephone line and each device which uses the telephone line.

In other embodiments additional componentry such as an amplifier may also be included into the output stage to boost the dialling code processors output to levels similar to those of other signals on the telephone line. In such an embodiment the current or voltage amplitude of the signal emitted may be amplified.

In a preferred embodiment the detected dialling signal is inverted to create an inverted signal. This inverted signal is substantially similar to the dialling signal detected with the exception that it is of the opposite polarity to the detected signal. However, it should be appreciated by those skilled in the art that the inverted signal formal may not be an exact inverse polarity replica of the dialling signal detected. Variations in the characteristics of this signal may occur due to the physical limitations of the inverter components used in accordance with the present invention.

Furthermore, provision may also be made in the construction or calculation of the inverted signal to leave uninverted a particular frequency range or frequency bands within the original dialling signal. For example in one embodiment a portion of the dialling signal present at approximately 425 hertz used to supply audio feedback to a dialling telephone device may be left uninverted in this instance. This will allow the present invention to cancel out dialling signals used to connect a telephone call but to leave untouched components of the original dialling signal which do not connect a call and which provide feedback to the dialling device or user.

This feature of the invention may be implemented in a number of different ways according to the particular physical components used to construct the dialling code processor. If, for example, in a preferred embodiment a microprocessor is used to apply an inverting and modifying algorithm to the digitised dialling signal, modifications may be made to the software used to implement such an algorithm to leave particular frequency bands uninverted or untouched. Alternatively, if discreet analogue components are used to implement components of the invention, specific band pass filters for the particular frequency range involved may be employed.

The inverted signal formed by the inverter is adapted to substantially cancel out the original dialling signal placed on the telephone line. When the dialling signal and the inverted signal are added together both signals sum to near zero. In this way the inverted signal generated may, when placed on a telephone line, cancel out the original dialling signal detected.

This feature of the present invention allows the dialling code processor to be connected in parallel into a structures telephone lines—allowing the device to service all the telephones connected to the telephone lines. The present invention may firstly detect or read the original dialling signal entered onto the telephone line from a telephone, facsimile or computer modem. Having read the signal entered the dialling code processor may then block this signal by placing an inverted version of the detected signal on the telephone line.

This means that a single dialling code processor connected in parallel may be used to perform the same function as the numerous dialling code processors previously used for multiple telephones in a building. The single parallel connection of the dialling code processor allows the device to be connected into a spare jack-point or telephone connection point with comparative ease.

Reference throughout the specification has also been made to the present invention including a detector, an inverter, a processor, a modifier and an output stage. It should be appreciated by those skilled in the art that some or all of the specific components discussed above may be implemented using a software algorithm loaded into a microprocessor or similar device. However, it is also possible that discreet electrical components may be used for some or all of the components of the invention specified, above.

Furthermore, reference to the addition of a code signal to the inverted dialling signal to form a modified signal should in no way be seen as limiting. Those skilled in the art should appreciate that the present invention may be used to block a dialling signal placed on a telephone line without the need for the addition of a further code signal to the telephone line to replace the blocked signal. The present invention may be used to initially block such dialling signals and apply any further code signals at a later time if required. Reference to the incorporation of a code signal into modified signal placed back on the telephone line involved throughout this specification should in no way be seen as limiting.

In a preferred embodiment a number of components of the present invention may be implemented through a software algorithm loaded into a microprocessor or other similar device. The microprocessor involved may be loaded with particular software modules used to implement the inverter, processor and modifier discussed above and used in accordance with the present invention.

In such instances the dialling code processor may include an analogue to digital converter component in the detector stage which samples the analogue signals on a telephone line and supplies a digital version of same to the microprocessor involved. The microprocessor may then execute an inversion and modification algorithm on the sampled signal to obtain a modified signal. This digital modified signal may then be converted into an analogue signal through a digital analogue converter incorporated into the output stage, and may be placed on a telephone line using the output stage.

Implementing the inverter, processor and modifier using software loaded onto a microprocessor provides significant advantages to the resulting dialling code processor and also allows it a certain degree of flexibility in range of operations it can complete. The inverting and modifying algorithm used can be adapted or tuned as required to compensate for different telephone line conditions and the characteristics of different equipment connected to the telephone line. The algorithm may be tuned in real time either by a technician at the same location as the dialling code processor—or alternatively through transmissions made over the telephone line directly to the dialing code processor.

Changes or adaptations can be made to the algorithm used if, for example, numerous different types of telephone equipment connected to the telephone line all emit a different type of dialling signal. The algorithm used may be tuned or adapted to compensate for these differences and to ensure that the invention will work with respect to all equipment connected to the line. Furthermore, the algorithm used may also be tuned to compensate for changes in the characteristics of the telephone line that can degrade with age or also change rapidly with different weather conditions.

In an alternative embodiment the present invention may be implemented using simple discreet electrical components. This configuration of the invention provides an alternative design path that may be used to implement the invention.

In such an alternative embodiment the inverter used may be a stand-alone operational amplifier. The detected dialling signal may be fed into the negative input of such an amplifier, which may provide an inverted signal at the output of the amplifier.

In a preferred embodiment the processor may be a standard microprocessor well known in the art. In a further preferred embodiment the processor used may be similar to that used with existing serial connection dialling code processors.

Preferably a number of components of the invention may be implemented through software loaded onto a main microprocessor. The processor discussed throughout this specification may therefore be defined as a portion of the software modules or algorithms which are used to calculate the modified signal to be placed on the telephone line. Those skilled in the art should appreciate that a dialling code processor in such instances may be implemented simply through a microprocessor combined with digital to analogue and analogue to digital converters without any other significant amounts of, electrical componentry.

A code signal generated by the processor in a preferred embodiment may be a signal that places the required dialling signal onto the telephone lines. The inverted signal discussed above may be used to cancel out the original dialing signal on the telephone line, and the coded signal may be used to replace the original dialling signal to ensure that a telephone call is connected through an alternative telecommunications network to the required number. In such an embodiment the code signal used may include the additional dialling digits required to access the alternative telecommunications network, and then the original telephone number dialled and placed on the telephone line.

However as discussed above the use of a code signal with the present invention should in no way be seen as limiting. Those skilled in the art should appreciate that the present invention may be used in its more basic forms to block a dialling signal placed on a telephone line. The further addition of a code signal to replace the blocked dialling signal be considered as an additional improvement to the present invention.

In a preferred embodiment the modified signal produced by the modifier may be the combination of the inverted signal and code signal produced by the present invention. These two signals may be combined to form a modified signal which, when placed on the telephone line will firstly cancel out the original dialling signal on the line and then add the new code signal to the telephone line.

It should be appreciated by those skilled in the art that the way these two signals are combined may vary depending on the type of dialling signal and communications protocols used on a telephone line. Depending on the particular situation, an appropriate form of combining the code and inverted signals may be selected and used by the modifier.

In a preferred embodiment a modifier used in conjunction with the present invention may be any device or software construction which combines the inverted and code signals to form the required modified signal.

In a preferred embodiment such a modifier may be implemented through a software module or algorithm loaded into a microprocessor. As discussed above, digital processing techniques may be used to invert a digital version of the dialling signal detected and to also add a modified signal to the inverted signal which will dial the digits required onto the telephone line.

In one alternative embodiment the modifier used may be a standard operational amplifier. As specified above, this operational amplifier may also be used as the inverter that inverts the original dialling signal detected.

In this embodiment the detected signal may be placed on the negative input of the amplifier and the code signal generated by the processor placed on the positive input of the amplifier. The amplifier will then invert the detected dialling signal and add this to the code signal to form the modified signal, The output of the amplifier may then be placed on the telephone line via a connection through a conductor.

Furthermore, in some alternative embodiments both the inverter and modifier may be implemented using a single operational amplifier. The detected signal may be applied to the negative input of the amplifier, whereas the code signal may be applied to the positive input of the amplifier. The amplifier's output will then be a combination of the inverted dialling signal added to the code signal.

However, preferred embodiments may not employ an operational amplifier as the modifier specified above. For example, in other embodiments micro-processing devices programmed with the appropriate software may be used as the modifier to ensure that the inverted and code signals are combined together in the required manner.

The present invention as discussed above provides many advantages over existing dialling code processors.

The present invention may be connected in parallel to a building's telecommunications lines. Parallel connection of the dialling code processor ensures that the single device may provide the same functions for all telephones or other telecommunications devices connected into a building's telephone lines. This may be contrasted with known dialling code processors, where a single device is required for each telephone, facsimile or modem to be connected onto a telephone line.

The present invention may be easily installed into a building's telecommunications networks by connection through a spare jack-point or connection point. There is no need for the dialling code processor to be connected into a building's telephone lines at a junction point which is difficult to reach or to work at.

The present invention also provides a fast connection to the telephone number dialled through an alternative telecommunications network. There are no significant delays between the operator entering a number into their telephone and this number then being accessed through an alternative telecommunications network. This may be contrasted with similar devices which, due to their construction, delay the connection of a call, resulting in frustration and annoyance to the telephone operator.

### BRIEF DESCRIPTION OF DRAWINGS

Further aspects of the present invention will become apparent from the ensuing description that is given by way of example only and with reference to the accompanying drawings in which:

FIG. 1 illustrates a block diagram of a known dialling code processor connected in series to a telecommunications network and a telephone;

FIG. 2 shows block diagram of a dialling code processor configured in accordance with one embodiment of the present invention connected in parallel to a telecommunications network, and

FIG. 3 shows in general terms electrical components used in the present invention in one embodiment, and

FIGS. 4a-c show a number of signals detected and placed on a telephone line in yet another embodiment of the present invention, and

FIG. 5 shows components used in the configuration of the present invention in another embodiment.

### BEST MODES FOR CARRYING OUT THE INVENTION

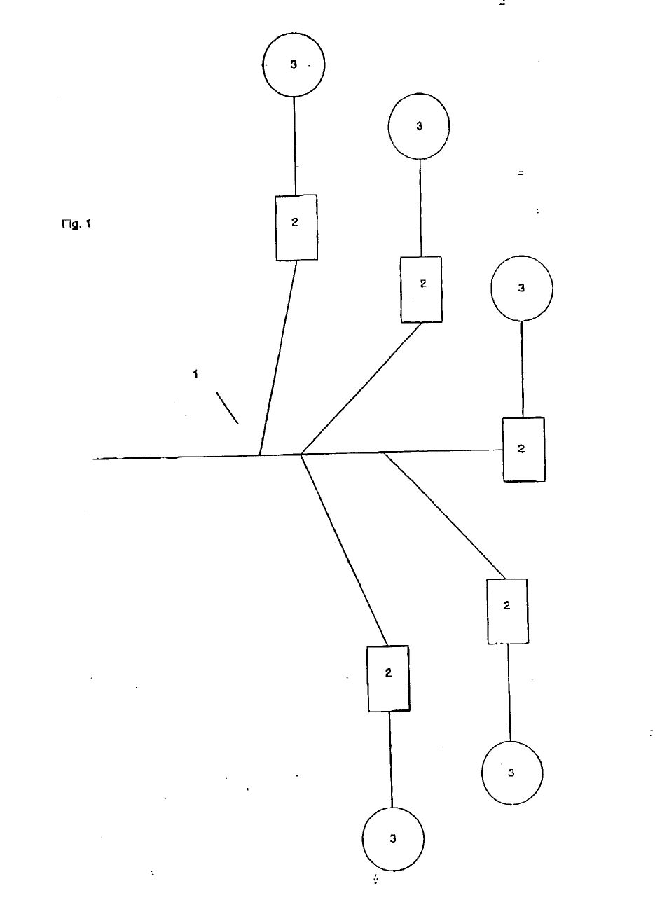

FIG. 1 shows a number of known dialling code processors connected in series between a telephone line 1 and a number of telephones 3. A dialling code processor 2 is connected in a series between the telephone line 1 and each telephone 3 to ensure that any number dialled on a telephone 3 is connected through an alternative telecommunications network (not shown) by the dialling code processor 2. The dialling code processor 2 is configured to automatically add access digits to the start of the number dialled on the telephone 3.

As can be seen from FIG. 1 a dialling code processor 2 is required for each telephone 3 to be connected to the telephone line 1. This substantially increases the costs associated with automatically connecting a number of telephones to an alternative telecommunications network.

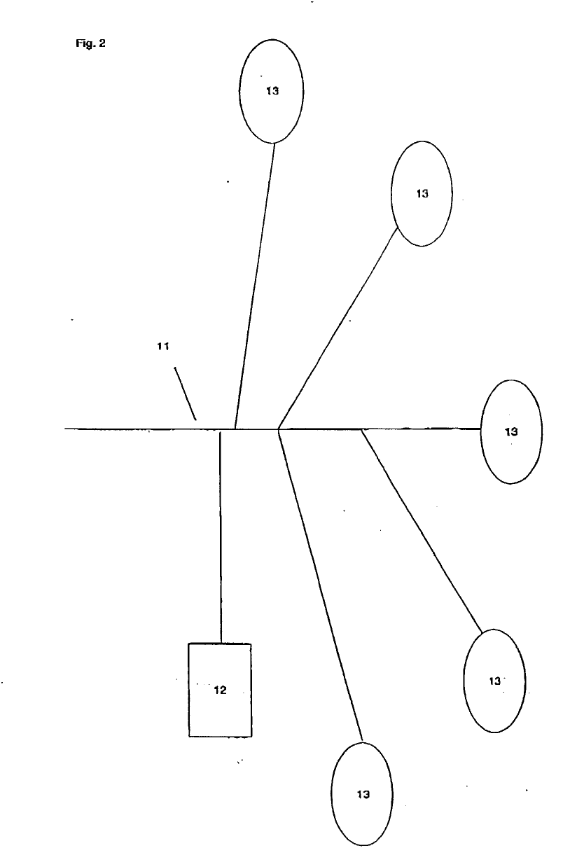

FIG. 2 shows a dialling code processor 12 configured and connected in accordance with one embodiment of the present invention.

The dialling code processor 12 is connected in parallel to a telecommunications network 11. Also connected in parallel to the same network 11 are a number of telephones 13.

When in use, a telephone number may be dialled on a telephone 13 and placed on the telephone line 11. The DCP 12 may detect the dialling signal placed on the line 11 and create and place its own modified signal on the telephone line 11. This modified signal will then cancel out the original dialing signal placed on the line by the telephone 13, and place a coded signal on the line, which will connect a call to the relevant number through an alternative telecommunications network.

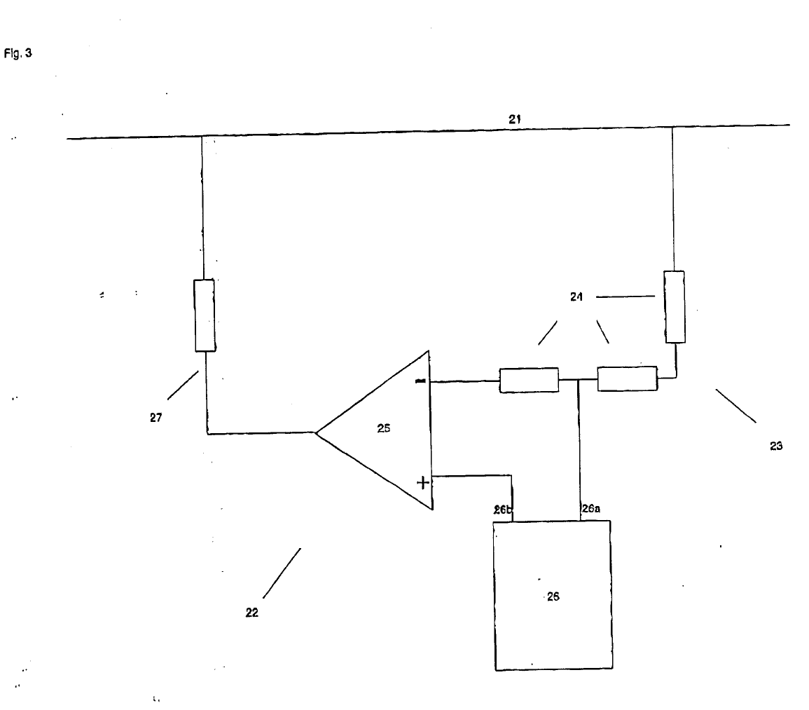

FIG. 3 shows in general terms a number of electrical components used to construct the present invention in another embodiment.

FIG. 3 shows a telephone line 21 connected to a dialling code processor 22. The DCP 22 includes a detector stage, made up by a physical connection to the telephone line 21 and a number of balancing components 24. The balancing components 24 arm incorporated to ensure that the correct voltage and current levels are supplied to each of the components of the DCP 22.

The end of the detector 23 is connected to the negative input of an amplifier 25. The detector 23 is also connected to the input port 26a of a processor 26. An output port 26b of the processor 26 is connected to the positive input of the amplifier 25.

The output of the amplifier 25 is then connected through an output stage 27 back onto the telephone line 21.

In use, a dialling signal is detected on the telephone line 21 by the detector 23. This dialling signal is then supplied via input port 26a to the processor 26 and also to the negative input of the amplifier 25.

Once the processor 26 receives the detected dialling signal it creates a code signal which incorporates the telephone number to be dialled and the additional digits required to access an alternative telecommunications network. The code signal produced is then transmitted via output port 26b to the positive input of the amplifier 25.

The negative input of the amplifier 25 inverts the detected dialling signal and adds this to the code signal produced by the processor. The amplifier 25 then outputs a modified signal which is a combination of the inverted dialling signal detected and the code signal. This modified signal is then placed back on the telephone line 21 via the output stage 27.

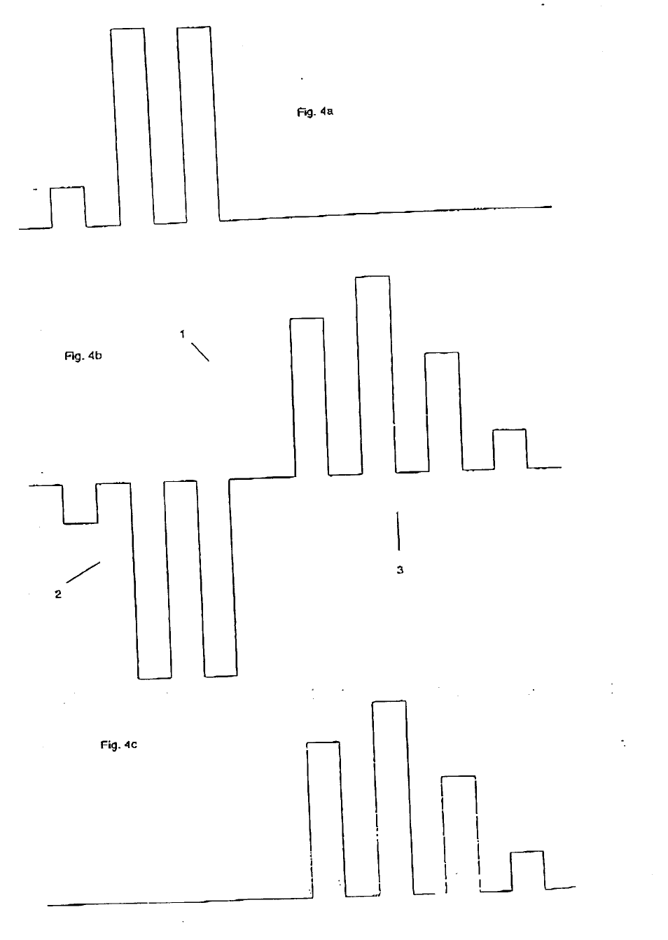

FIG. 4 shows a number of signals detected and placed on a telephone line in accordance with the present invention.

FIG. 4a shows a dialling signal detected on a telephone line in one embodiment of the present invention. Each of the pulses placed on the line may convey specific information as to which telephone number was dialled using a telephone.

FIG. 4b shows a modified signal placed on a telephone line in response to the detection of the dialling signal shown in FIG. 4a. The modified signal 1 includes an inverted signal 2 which is an inverted version of the dialling signal of FIG. 4a. The modified signal 1 also includes a code signal 3.

FIG. 4c shows the signal remaining on the telephone line when the modified signal 1 is placed on the telephone line after the dialling code processor detects the dialling signal of FIG. 4a. As can be seen from FIG. 4c the inverted signal 2 of FIG. 4b cancels out the dialling signal of FIG. 4a, leaving only the code signal 3 of FIG. 4b on the telephone line to dial the required telephone number through an alternative telecommunications network.

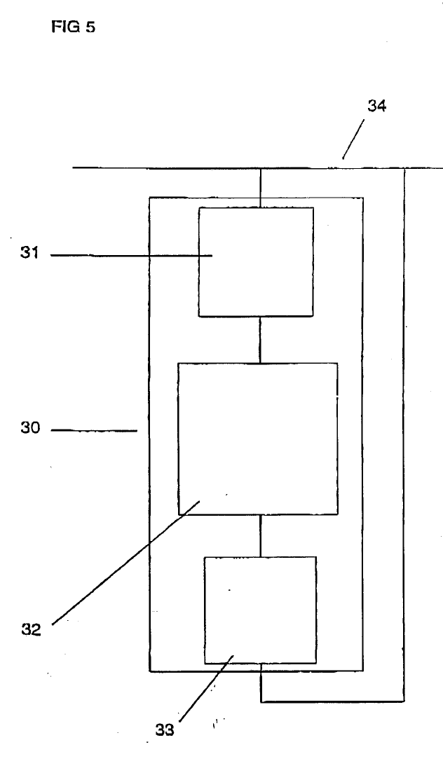

FIG. 5 shows a detailed schematic of components used to construct the present invention in another embodiment. In the embodiment shown a dialling code processor 30 is implemented using a detector stage 31 which incorporates an analogue to digital converter, and the inverter processor and modifier components of the apparatus are implemented through software modules loaded into a microprocessor 32. Furthermore, an output stage 33 of the DCP also includes a digital to analogue converter which is adapted to convert a digital signal supplied by the microprocessor 32 into an analogue signal to be placed on a telephone line 34.

In the embodiment shown the inverter, processor and modifier of the DCP need not necessarily be implemented by three discreet components. In this instance digital signal processing techniques may be used to construct an algorithm which will invert an original dialling signal and add a code signal which will dial the digits required onto the telephone line 34.

Aspects of the present invention have been described by way of example only and it should be appreciated that modifications and additions may be made thereto without departing from the scope thereof as defined in the appended claims.

What we claim is:

1. A method of operating a dialling code processor, characterised by the steps of:
(a) detecting at least one dialling signal placed on a telephone line, and
(b) inverting the detector signal to form a modified signal, and
(c) placing the modified signal on the telephone line,
wherein the modified signal is adapted to substantially cancel out the original detected dialling signal on the telephone line.

2. A method of operating a dialling code processor, as claimed in claim 1, further characterised by the steps of:
(a) detecting at least one dialling signal placed on a telephone line, and
(b) inverting the detected signal, and
(c) modifying the inverted signal to form a modified signal which includes an additional code signal, and
(d) placing the modified signal on the telephone line,
wherein the modified signal is adapted to substantially cancel out the original detected dialling signal on the telephone line and to place the additional code signal on the telephone line.

3. A method of operating a dialling code processor as claimed in claim 1 wherein the dialling code processor is connected to a telephone line in parallel with at least one other device connected to the same telephone line.

4. A method of operating a dialling code processor as claimed in claim 1 wherein the dialling signal is any signal placed on a telephone line to connect a telephone call.

5. A method of operating a dialling code processor as claimed in claim 1 wherein the inverted signed when placed on the telephone line is adapted to substantially cancel out the original dialling signal detected.

6. A method of operating a dialling code processor as claimed in claim 2 wherein the code signal is adapted to place a signal on the telephone line to connect a telephone call.

7. A method of operating a dialling code processor as claimed in claim 2 wherein the modified signal is a combination of the inverted signal and the code signal.

8. A dialling code processor which includes a detector, an inverter and an output stage.

9. A dialling code processor as claimed in claim 8 which includes a detector, an inverter, a processor, a modifier and an output stage.

10. A dialling code processor, as claimed in claim 9 wherein the detector is adapted to detect
a dialling signal on a telephone line, and
the inverter is adapted to invert the signal detected by the detector, and
the processor is adapted to generate a code signal, and
the modifier is adapted to combine the code signal and the inverted signal supplied by the inverter, and
the output stage is adapted to place the output of the modifier on the telephone line.

11. A dialling claim processor as claimed in claim 9 wherein the inverter, processor and modifier are formed by software loaded into a microprocessor.

12. A dialling code processor as claimed in claim 8 which is connected to a telephone line in parallel with at least one other device connected to the same telephone line.

13. A dialling code processor as claimed in claim 8 wherein the detector includes a conductor connected to the telephone line.

14. A dialling code processor as claimed in claim 8 wherein the detector includes capacitive and/or resistive elements to modify the electrical parameters of the dialling signal detected.

15. A dialling code processor as claimed in claim 8 wherein the processor is formed using a microprocessor.

16. A dialling code processor as claimed in claim 9 wherein the modifier and the inverted are formed from a single operational amplifier.

17. A dialling code processor as claimed in claim 16 wherein the detected signal is applied to the negative input of the amplifier.

18. A dialling code processor as claimed claim 16 wherein the code signal is applied to the positive input of the amplifier.

19. A dialling code processor as claimed in claim 7 wherein the output stage includes a conductor physically connected to the telephone line.

20. A dialling code processor as claimed in claim 7 wherein the output stage includes an amplifier to boost the amplitude of the modified signal placed on the telephone line.
